(19) United States
(12) Patent Application Publication
(10) Pub. No.: US 2004/0082318 A1
(43) Pub. Date: Apr. 29, 2004

(54) Transit vehicle wireless broadcast system

(76) Inventor: David E. Lane, New York, NY (US)

Correspondence Address: PATTON BOGGS, PO BOX 270930, LOUISVILLE, CO, 80027, US

(21) Appl. No.: 10/279,426

(22) Filed: Oct. 24, 2002

(51) Int. Cl. H04Q 7/20

(52) U.S. Cl. 455/414.1; 455/412.1; 455/456.3

(57) ABSTRACT

The present transit wireless broadcast system wirelessly broadcasts multimedia content to passengers traveling in transit vehicles. The multimedia content stored on a storage device is retrieved, converted to a predetermined wireless frequency and the broadcast to the passengers. The wirelessly transmitted multimedia content may be received by devices and within the transit vehicle for delivery of the multimedia content to the passengers. The multimedia content may be prerecorded content or may be wireless received at the transit vehicle, converted, and stored on a storage device.

### FIELD OF THE INVENTION

This invention relates to broadcast systems, and more particularly to a transit vehicle multimedia broadcast system that wirelessly broadcast multimedia to passengers traveling in the transit vehicle.

### Problem

It is a problem in the field of broadcast system to provide continuous wireless broadcast for passengers traveling a transit vehicle. Known systems for broadcasting audio and/or video to passengers traveling in transit vehicles are closed circuits systems.

Closed circuit systems are limited to broadcast apparatus that read and distribute prerecorded content stored on cassettes, discs or other storage medium to audio/visual devices connected to the broadcast apparatus. Another closed circuit broadcast system is not limited to broadcast of prerecorded content. Instead the system wirelessly receives traditional wireless content and broadcast the received content to passengers traveling on the transit vehicle. For example, JetBlue Airways provides satellite TV with DirecTV® programming while the airplane is traveling in areas that receive the traditional wireless broadcast. Wireless broadcast includes AM/FM audio and television signals received by individual radio receivers or television receivers and cellular broadcast for cellular telephones or other devices capable of receiving cellular frequencies. Wireless broadcast is aerial and is blocked by some solid masses or objects and the signals weaken with distance. Areas that are unable to receive the wireless broadcasts are said to be out of the broadcast range. Wireless broadcast is not suitable for transit vehicles traveling in a closed environment, such as underground subways and commuter trains, vehicles traveling in remote areas, trains and busses, or vehicles traveling at speeds that prevent hand-off of cellular signals or reception of continuous AM/FM or video broadcasts.

A system for providing wireless Internet access from a transit vehicle is disclosed in Patent Number 00890907/EP B1 issued to Goerke et al., wherein the vehicle is provided with a web server and a wireless link from the server to the web for use while the transit vehicle is in motion. During transit, the web server is operable to store email messages produced by the passengers. When the transit vehicle is stationary and within broadcast range, the stored e-mail is transmitted from the transit vehicle. While the system allows passengers to send and receive email messages via the Internet, the actual transmission is limited to when the transit vehicle is stationary and within broadcast range. Therefore, the system does not provide wireless multimedia broadcasts to the passengers while the transit vehicle is in motion. In other words, the system is limited to use for saving email messages during transit and is further limited by the requirement for the transit vehicle to be stationary in an area having traditional wireless access.

Another system that discloses use of the Internet for wireless connectivity from a transit vehicle is described in a technical publication by Baroody, R, Al-Holou, N. and Hariri, S., “Development of car Intranet infrastructure”, Society of Automotive Engineers, Mar. 4, 2002, page 1658. Baroody discloses a Media-Oriented System Transport (MOST) that provides high bandwidth for new applications, such as in-vehicle multimedia, entertainment, navigation, and computing. The infrastructure disclosed provides new services that can be delivered to cars through wireless data connectivity over the Internet.

Like Goerke, this system is limited to transmission of wireless data via the Internet and does not provide wireless broadcasts to passengers while the vehicle is traveling in areas that lack traditional wireless broadcasts. However, while Goerke requires the transit vehicle to be stationary to send the stored e-mail, the system in Baroody allows wireless connectivity while the transit vehicle is within range of traditional wireless transmission sites. Neither system provides a method for wirelessly transmitting stored multimedia data to passengers while the transit vehicle is in motion and traveling in areas that lack traditional broadcast reception.

A system that wirelessly broadcasts audio to passengers traveling in a transit vehicle is disclosed in journal the paper published in Germany titled “German Federal Railways provides intercity express trains with optical fiber communication system”. Reuber, C., German Federal Railways provides intercity express trains with optical fiber communication system, Elektron, J., Vol. 25 No. 16, 17 August 1990, p. 28. In Reuber, radio stations provide optical signals that are transmitted by an optical system that feeds optoelectronic amplifiers that are within a tunnel. These amplifiers radiate the original radio frequencies from high frequency slotted conductors for wireless communication with passing trains. Optical cables within the train may also be used to form part of a multiplexed data transmission system between end locomotives and carriages for control of braking, lights, doors and other functions. The system disclosed by Reuber is limited to extending the broadcast area for radio stations and the broadcast is within a tunnel and may also be used for passing control information to the interconnected cars. The system does not provide for the broadcast of other types of multimedia data to passengers or broadcast to passengers traveling in other areas where traditional broadcast is lacking, such as remote locations or in the mountains.

For these reasons, a need exists for a broadcast system that wirelessly transmits multimedia content within the transit vehicle for broadcast on devices capable of receiving the wireless multimedia.

### Solution

The present transit vehicle wireless broadcast system wirelessly broadcasts audio, video, graphic and/or text messages to passengers that are traveling in transit vehicles. The multimedia content stored on a storage device is retrieved, converted to a predetermined wireless frequency and broadcast to the passengers. The wirelessly transmitted multimedia content may be received by wireless devices within the transit vehicle for broadcast to the passengers, or alternatively, may be received by hand held devices in the possession of passengers and that are capable of receiving the predetermined wireless frequency. The multimedia content stored in the storage device may be prerecorded multimedia content or may be downloaded to the transit vehicle via a receiver while the transit vehicle is within range for receiving wirelessly transmitted multimedia content. Alternatively, the multimedia content may be wirelessly delivered to the transit vehicle while the transit vehicle is within wireless range and wirelessly broadcasting, in real time, the multimedia content to passengers. Alternatively, the wirelessly received multimedia content may be stored on a storage device for later broadcast.

### BRIEF DESCRIPTION OF THE DRAWINGS

FIG. 1 illustrates a block schematic of the present transit vehicle wireless broadcast system;

FIG. 2 illustrates a flow diagram of the operation of the system of FIG. 1;

FIG. 3 illustrates a block schematic of another embodiment of the present transit vehicle wireless broadcast system;

FIG. 4 illustrates a flow diagram of the operation of the system of FIG. 3;

FIG. 5 illustrates a block schematic of another embodiment of the present transit vehicle wireless broadcast system; and

FIG. 6 illustrates a flow diagram of the operation of the system of FIG. 5.

### DETAILED DESCRIPTION

The transit vehicle wireless broadcast system summarized above and defined by the enumerated claims may be better understood by referring to the following detailed description, which should be read in conjunction with the accompanying drawings. This detailed description of the preferred embodiment is not intended to limit the enumerated claims, but to serve as a particular example thereof. In addition, the phraseology and terminology employed herein is for the purpose of description, and not of limitation.

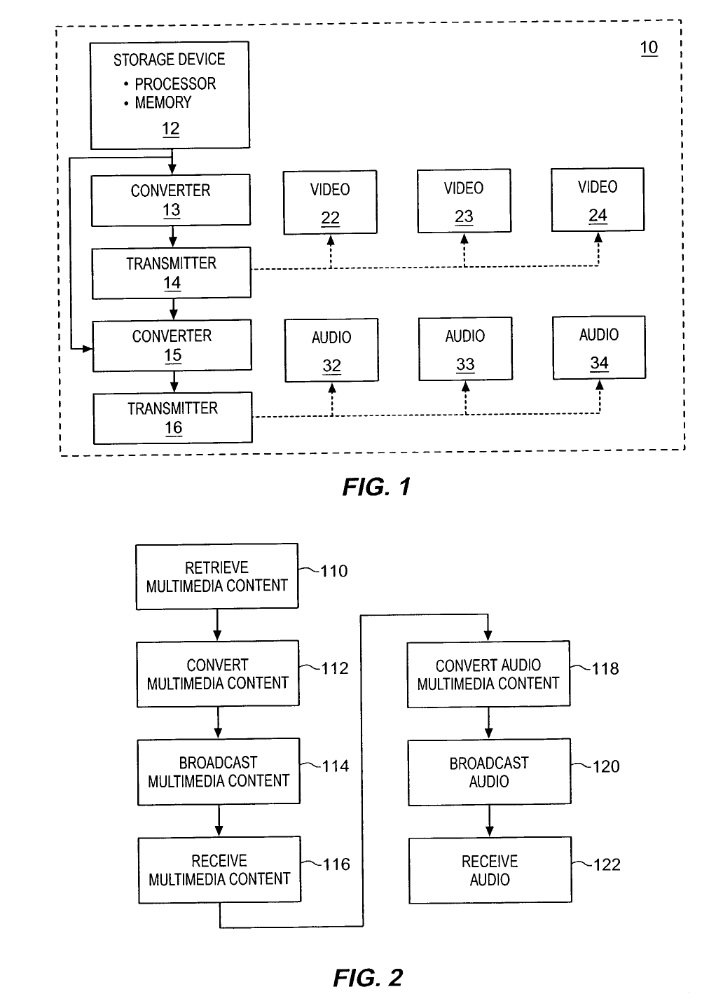

Referring to the block diagram of FIG. 1, the present transit vehicle wireless broadcast system includes a storage device 12 for storing multimedia content for broadcasting stored audio, video, graphic and/or text messages to passengers in the transit vehicle. Storage device 12 may include a memory for storing software for operation of the storage device as well as storing the multimedia content and a processor for executing the stored software in accordance with the following description. The storage device is connected to a transmitter 14 for wirelessly broadcasting the multimedia content, audio, video, graphic, text or a combination thereof, to the passengers. A converter 13 may be connected between the storage device 12 and the transmitter 14 for converting the stored multimedia content to a predetermined wireless frequency for broadcast.

The multimedia content may be prerecorded content or may be wirelessly downloaded to the transit vehicle. The multimedia content is illustrated and described as residing in memory within storage device 12, although the multimedia content may be stored on an alternative medium for distribution via a device capable of retrieving the multimedia content from the alternative medium, such as a combination of a storage disk and a disk player. Likewise, the multimedia content may be downloaded and stored on the storage device 12 for broadcast at a later time.

Referring to the flow diagram of FIG. 2, operationally, the multimedia content is retrieved from storage device 12 in step 110. The multimedia content retrieved in step 110 is converted to a predetermined wireless frequency in step 112 and wirelessly broadcast within the transit vehicle in step 114. Referring back to FIG. 1, the broadcast multimedia content may be received in step 116 by wireless video devices 22-24 or wireless audio devices 32-34 in step 116, or a combination of audio and wireless video devices. Wireless video devices 22-24 and wireless audio devices 32-34 may be located within the transit vehicle 10 for broadcasting the multimedia content to the passengers. Alternatively, the wireless audio and or wireless video devices receiving the broadcast multimedia content in step 116 may be passenger radios, laptop computers including wireless connection, cell phones, or any other device capable of receiving the wireless transmission of multimedia content. The multimedia data may include graphics, text, audio, video, or any combination thereof.

Alternatively, the multimedia content broadcast in step 114 may be received by one or more wireless video graphic devices 22-24 for delivery to the passengers traveling in the transit vehicle. The broadcast system may further include a second converter 15 for converting an audio portion of the multimedia content to another predetermined frequency in step 118. In this embodiment, the predetermined frequency is then wirelessly broadcast in step 120 to passengers for receipt in step 122 by handheld wireless devices 32-34 in the possession of the passengers. The second converter 15 and second transmitter 16 for broadcasting the audio portion of the multimedia content may be integral to the video graphic devices 22-24 (not shown) or may be an alternative configuration as illustrated in FIG. 1.

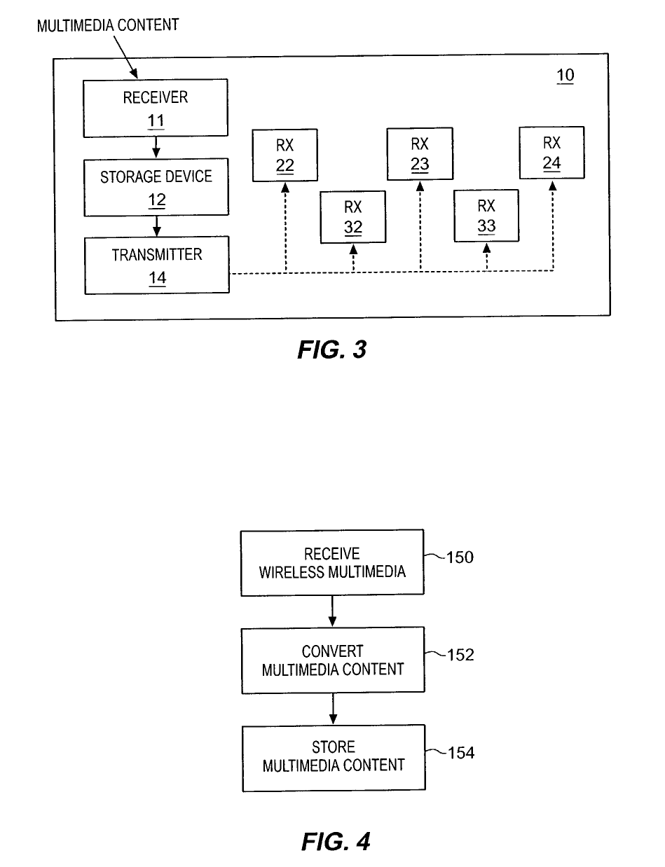

Referring to the block schematic diagram of FIG. 3, in another embodiment, multimedia content is downloaded to a receiver 11 on the transit vehicle 10. The downloaded multimedia contented is stored in storage device 12 for later broadcasting stored audio, video, graphic and/or text messages to passengers in the transit vehicle. Referring to the flow diagram of FIG. 4, the multimedia content is received in step 150 at receiver 11 and converted in step 152 for storage on storage device 12. Following the previously described method illustrated in FIG. 2, for broadcast to passengers, the stored multimedia content is retrieved in step 110 and converted in step 112 to a predetermined wireless frequency. The converted multimedia content is broadcast to passengers in step 114 which may be receive in step 116 by wireless receivers 22-24 and 32-33 located in the transit vehicle or wireless hand held device that are in the possession of passengers and are capable of receiving the predetermined wireless frequency. In this embodiment, updated multimedia content may be wirelessly downloaded to the transit vehicle and stored for later broadcast to the passengers.

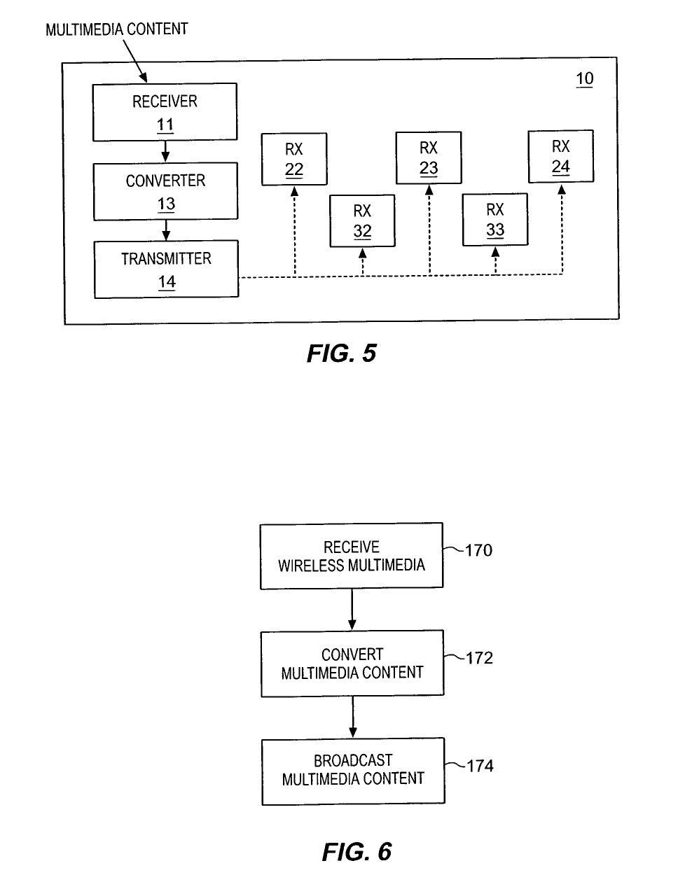

In another embodiment illustrated in FIG. 5, the multimedia content is wirelessly received at receiver 11 and wireless broadcast to passengers as the multimedia content is received. Referring to the flow diagram of FIG. 6, the multimedia content is received in step 170 and converted a predetermined wireless frequency in step 172 by converter 13. The predetermined wireless frequency from converter 13 is broadcast in step 174 to passengers by transmitter 14 for receipt by wireless receivers 22-24 and 32-33 within the transit vehicle or in the possession of passengers. The transit vehicle wireless broadcast system in this embodiment may be traveling within range for traditional broadcast reception, receive the multimedia content and convert the multimedia to a predetermined wireless frequency and broadcast, in real time, the received multimedia content for delivery to wireless receivers located within the transit vehicle and capable of receiving the predetermined wireless frequency.

The transit vehicle in which the multimedia content is wirelessly broadcast may be traveling in an area that lacks traditional broadcast, an area where the transit vehicle travels a portion of a predetermined route in an area where traditional broadcast is lacking or an area that receives traditional wireless broadcast.

As to alternative embodiments, those skilled in the art will appreciate that the present transit vehicle wireless broadcast system may be implemented with alternative configurations. While the multimedia content has been illustrated and described for broadcast to passengers via wireless video and audio devices within the transit vehicle, alternative configurations may be substituted. For example, the multimedia content may be audio broadcast via speakers within the transit vehicle or may be audio, video, graphic, text, or a combination thereof that is wirelessly broadcast for receipt by handheld devices in the possession of passengers that are capable of receiving the wireless multimedia. Similarly, while the multimedia content has been illustrated and described as residing in memory within the storage device, the audio and/or audio/video content may be stored on an alternative medium for distribution via a device capable of retrieving the multimedia content from the alternative medium, such as a combination of a storage disk and a disk player.

It is apparent that there has been described a transit vehicle wireless broadcast system that fully satisfies the objects, aims, and advantages set forth above. While the present transit vehicle wireless broadcast system has been described in conjunction with specific embodiments thereof, it is evident that many alternatives, modifications, and/or variations can be devised by those skilled in the art in light of the foregoing description. Accordingly, this description is intended to embrace all such alternatives, modifications and variations as fall within the spirit and scope of the appended claims.

What is claimed is:

1. A broadcast system for wirelessly broadcasting multimedia content to passengers in a transit vehicle, said system comprising:
a means for storing aid multimedia content in said transit vehicle;
a means for wirelessly broadcasting said multimedia content within said transit vehicle.

2. The system of claim 1 wherein said wireless broadcasting means comprises:
a means for converting said multimedia content to a predetermined wireless frequency; and
a means for wirelessly transmitting said multimedia content at said predetermined wireless frequency within said transit vehicle.

3. The system of claim 1 further comprising:
a means for wirelessly receiving said multimedia content at said transit vehicle 10 for broadcast to said passengers traveling in said transit vehicle.

4. The system of claim 1 further comprising:
a means for wirelessly receiving said multimedia content at a video graphic display means for delivering said multimedia content to said passengers traveling in said transit vehicle.

5. The system of claim 4 wherein said wireless receiving means further comprises:
a means for converting an audio portion of said wirelessly received multimedia content to a predetermined radio frequency for receipt by audio devices capable of said predetermined radio frequency.

6. A broadcast system for wirelessly broadcasting multimedia content to passengers in a transit vehicle, said system comprising:
a means for wirelessly receiving said multimedia content in said transit vehicle 10;
a first means for converting said multimedia content to a predetermined wireless frequency; and
a means for wirelessly broadcasting said predetermined frequency within said transit vehicle.

7. The broadcast system of claim 6 further comprising:
a means for storing said multimedia content on said transit vehicle.

8. The broadcast system of claim 6 further comprising:
a means for wirelessly receiving said multimedia content at a video graphic display means for delivering said multimedia content to said passengers traveling in said transit vehicle.

9. The broadcast system of claim 8 further comprising:
a second means for converting an audio portion of said multimedia content to a second predetermined frequency; and
a second means for wirelessly broadcasting said second predetermined frequency for receipt by wireless devices that are capable of receiving said second predetermined wireless frequency.

10. A wireless multimedia broadcast system for wirelessly broadcasting a multimedia content to a plurality of passengers traveling in a transit vehicle 10 in areas where traditional wireless broadcast is lacking, the system comprising:
a storage device for storing said multimedia content;
a first transmitter for wirelessly transmitting said multimedia content within said transit vehicle; and
a receiver and for wirelessly receiving said wirelessly transmitted multimedia content for delivery to passengers traveling in said transit vehicle.

11. The wireless multimedia broadcast system of claim 10 further comprising:
a first converter for converting said multimedia content to a predetermined wireless frequency for broadcast via said first transmitter.

12. The wireless multimedia broadcast system of claim 10 further comprising:
a second converter for converting said multimedia content to a second predetermined wireless frequency for broadcast via a second transmitter.

13. The wireless multimedia broadcast system of claim 10 wherein said receiver comprises at least one of:
a video graphic display for displaying said multimedia content to said plurality of passengers traveling in said transit vehicle;
an audio receiver for delivering said multimedia content to said plurality of passengers traveling in said transit vehicle; and
an audio/video receiver for wirelessly receiving said multimedia content for delivering said multimedia content to said plurality of passengers traveling in said transit vehicle.

14. A method for wirelessly broadcasting multimedia content to a plurality of passengers traveling in a transit vehicle, comprising:
retrieving said multimedia content from a storage device 12 located within said transit vehicle; and
wirelessly broadcasting said retrieved multimedia content to said plurality of passengers while said transit vehicle is in transit.

15. The method of claim 14 wherein said wirelessly broadcasting comprises:
converting said retrieved multimedia content to a predetermined frequency; and
wirelessly transmitting said multimedia content within said transit vehicle at said predetermined frequency.

16. The method of claim 14 further comprising:
receiving said multimedia content at a receiving device located within said transit vehicle for broadcast to said plurality of passengers traveling in said transit vehicle; and
storing said received multimedia content at said storage device within said transit vehicle.

17. The method of claim 16 further comprising:
retrieving said multimedia content from a storage device located within said transit vehicle; and
wirelessly broadcasting said retrieved multimedia content to said plurality of passengers while said transit vehicle is in transit.

18. A method for wirelessly broadcasting multimedia content to passengers traveling within a transit vehicle, comprising:
receiving said multimedia content by a receiving device located on said transit vehicle;
converting said received multimedia content to a predetermined wireless frequency; and
broadcasting said predetermined wireless frequency for delivery of said multimedia content to said passengers traveling on said transit vehicle.

19. The method of claim 18 further comprising:
converting an audio portion of said multimedia content to a predetermined radio frequency; and
broadcasting predetermined radio frequency within said transit vehicle for delivering said audio portion of said multimedia content to said passengers traveling on said transit vehicle.
